(19) United States
(12) Patent Application Publication
(10) Pub. No.: US 2022/0252186 A1
(43) Pub. Date: Aug. 11, 2022

(54) FLUID LINE HAVING A PIPE

(71) Applicant: NORMA Germany GmbH, Maintal (DE)

(72) Inventor: Andreas Bauer, Obernburg (DE)

(21) Appl. No.: 17/627,726

(22) PCT Filed: Jul. 13, 2020
(86) PCT No.: PCT/EP2020/069702

§ 371 Date: Jan. 17, 2022

(30) Foreign Application Priority Data
Jul. 15, 2019 (DE) 10 2019 119 108.4

(51) Int. Cl. F16L 11/04; B60L 58/26; B32B 1/08; B32B 27/08; B32B 27/34; B32B 27/32; B32B 27/28

(52) U.S. Cl. CPC F16L 11/04; B60L 58/26; B32B 1/08; B32B 27/08; B32B 27/34; H01M 10/613; B32B 27/286; F16L 11/045; B32B 2250/24; B32B 2307/7265; B32B 27/32

(57) ABSTRACT

The disclosure relates to a fluid line having a pipe which includes at least two plastic layers. A first plastic layer includes hydrolysis-resistant polyamide 6 (PA6). The disclosure provides a fluid line which may be cost-effective.

### INTRODUCTION

The disclosure relates to a fluid line having a pipe.

Lines for transporting fluids, such as cooling water in vehicles, for example, must typically meet specific requirements during service. Hence the material of the line must typically not be dissolved by the fluid. This is to be avoided at relatively high temperatures as well. Further, the line must typically be impermeable to the fluid transported and to its chemical components, so that the fluid cannot pass through the walls of the line. The intention thereby is first to prevent a reduction in the quality of the transported fluid and secondly to prevent penetration of the fluid into the pipe wall of the line, in order to prevent changes to the material of the pipe wall. Further, instances of leaching are to be avoided. This is relevant especially when the fluid stands in the line, i.e., when at least intermittently there is no fluid transport. Furthermore, the lines are often required to have mechanical properties allowing the line to be connected simply and reliably to other line components.

The use of multilayer plastics lines is known practice. These plastics lines comprise plastics which exhibit the above-stated properties in relation to water and water-containing fluids. The plastics in question and their processing, however, can be comparatively expensive. Other, more favorable plastics, such as polyamide 6 , for example, are not used in the prior art, since these plastics are dissolved by water and/or suffer alteration in their physical properties as a result of the absorption of water. In the event of absorption of water, for example, the material may undergo an increase in volume, or damage. Even a protective layer of a water-impervious material such as polypropylene, polyamide 12 or polythalamide, for example, does not provide adequate protection against the diffusion of water molecules into the interior of the pipe material of the fluid line.

### SUMMARY

It is an object of the disclosure, according to an embodiment, to provide a fluid line which is inexpensive.

In a fluid line having a pipe which comprises at least two plastics layers, according to an embodiment of the disclosure, a first plastics layer comprises hydrolysis-resistant polyamide 6 (PA6).

One aspect of the disclosure, per an embodiment, is the use of hydrolysis-resistant polyamide 6 in at least one of the two plastics layers of the fluid line. The hydrolysis-resistant polyamide 6 is damaged to a lesser extent by water absorption than customary polyamide 6. Accordingly the hydrolysis-resistant polyamide 6 of the first plastics layer is not altered or dissolved, or is altered or dissolved to a lesser extent, by the water molecules than customary polyamide 6. It is possible accordingly for the first time to use a polyamide 6 material for producing a fluid line for carrying water. The hydrolysis-resistant polyamide 6 may be inexpensive and, when used to produce a basic structure for the fluid line, may mean that there is less of a need for other, more expensive materials. In particular, less polyamide 12 can be used, which is commonly more expensive by comparison with polyamide 6. Fluid lines comprising the hydrolysis resistant polyamide 6 have acceptable properties when utilized as lines for water and are nevertheless inexpensive.

A second plastics layer may be free from hydrolysis-resistant polyamide 6 (PA6 ).

The second plastics layer may therefore consist of a different material from the hydrolysis-resistant polyamide 6. In this way, for example, reinforcing layers or barrier layers can be produced for the fluid line.

Additionally, in one example, the second plastics layer may extend around the first plastics layer.

The second plastics layer is therefore disposed externally on the fluid line, as seen from the first plastics layer.

The second plastics layer here may comprise polyamide 612 (PA612).

A second plastics layer of polyamide 612 embraces effective media resistance with respect to greases, oils, motor fuels, hydraulic fluids, water and alkalis. If the fluid line is used in an environment in which these substances may reach the outer layer of the pipe, the inner layers, especially the first plastics layer, are protected by the second plastics layer. Thus the second plastics layer forms a protective layer with respect to external influences for the inner layers, especially for the first plastics layer. The second plastics layer, moreover, is therefore elastic.

Alternatively or additionally the second plastics layer may comprise polyamide 610 (PA610).

A second plastics layer of polyamide 610 therefore comprises a polyamide suitable for extrusion. Moreover, polyamide 610 is highly flexible while nevertheless being highly robust. In addition, polyamide 610 likewise protects the underlying plastics layers, especially the first plastics layer, from other fluids used, for example, in a vehicle.

In another example, the first plastics layer may extend around the second plastics layer.

In this case, the second plastics layer is disposed more inwardly in the fluid line than the first plastics layer.

The second plastics layer may comprise polypropylene (PP). Alternatively or additionally the second plastics layer may comprise polyethylene (PE).

Polypropylene and polyethylene both have good thermal properties and can be used as a barrier layer with respect to the medium water, for example flowing in the fluid line. They therefore reduce the contact of the hydrolysis-resistant polyamide 6 with water molecules.

Further, alternatively or additionally, the second plastics layer may comprise polyphenylene sulfide (PPS).

Polypropylene sulfide exhibits further-improved thermal properties relative to polypropylene or polyethylene.

The fluid line may comprise at least three plastics layers, where the first plastics layer is disposed between the second plastics layer and a third plastics layer.

The first plastics layer composed of the hydrolysis-resistant polyamide 6 may therefore form the basic structure of the fluid line. The second plastics layer and the third plastics layer may in this case shield the first plastics layer with respect to external influences and/or with respect to the medium flowing in the fluid line.

The third plastics layer may be free from hydrolysis-resistant polyamide 6.

The first plastics layer, moreover, according to certain embodiments may comprise in radial direction between 25% and 75%, preferably between 30% and 70%, more preferably between 40% and 60% of a total extent of the at least two plastics layers of the pipe.

This means that the wall thickness of the pipe of the fluid line is formed to an extent of 25% to 75% by the first plastics layer. The greater the proportion of the first plastics layer composed of the inexpensive hydrolysis-resistant polyamide 6, the more inexpensive the fluid line formed can be.

The disclosure further relates to a cooling water system for a vehicle, where the cooling water system comprises a cooling device, an element to be cooled and at least one fluid line according to the preceding description, where the at least one fluid line fluidically connects the cooling device and the element to be cooled.

Advantages and effects and also developments of the cooling water system, according to certain embodiments, are apparent from the advantages and effects and also developments of the fluid line described above. In this respect, therefore, reference is made to the foregoing description.

In a further embodiment, the disclosure relates to the use of a fluid line in accordance with the preceding description for conveying water in a vehicle.

Advantages and effects and also developments of the use of the fluid line, according to certain embodiments, are apparent from the advantages and effects and also developments of the fluid line described above. In this respect, therefore, reference is made to the foregoing description.

### BRIEF DESCRIPTION OF THE FIGURES

Further features, details and advantages of the disclosure are apparent from the wording of the claims and also from the following description of exemplary embodiments with reference to the drawings, in which:

FIG. 1 shows a schematic representation of a fluid line having at least two plastics layers;

FIGS. 2a-c show various examples of a schematic sectional representation of a fluid line according to FIG. 1;

FIG. 3 shows a schematic representation of a cooling water system with the fluid line; and

FIG. 4 shows a schematic representation of a vehicle with the fluid line.

### DETAILED DESCRIPTION

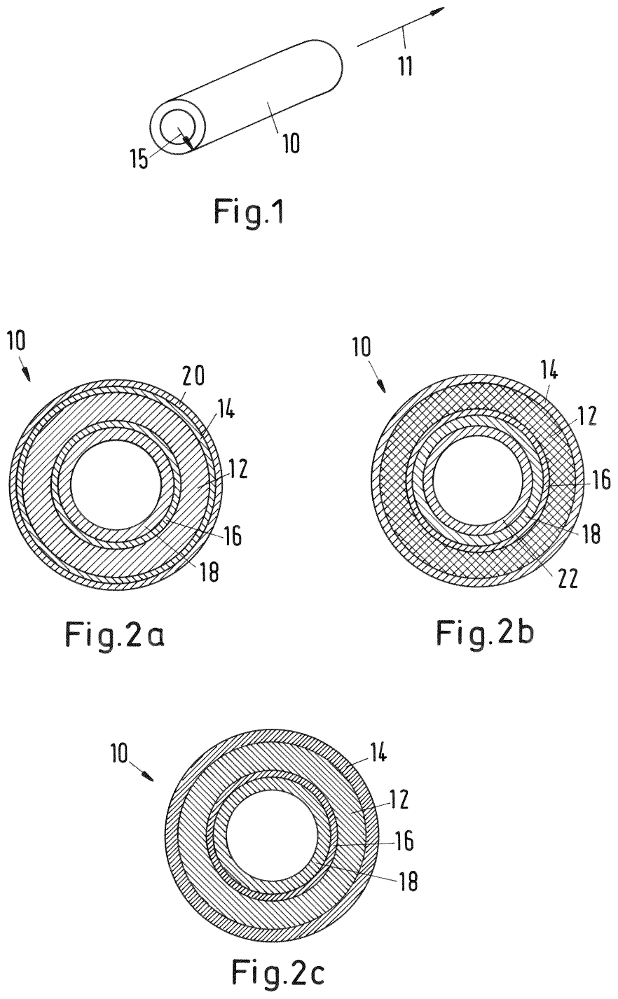

FIG. 1 shows a schematic representation and an embodiment of a fluid line in its entirety with the reference numeral 10.

This fluid line 10 extends along a direction 11 of extent. The radial direction 15 of the fluid line 10 is defined at right angles to this direction 11 of extent.

FIGS. 2a to 2c show sectional views of various examples of a fluid line 10 according to FIG. 1.

FIG. 2a here shows an example embodiment having a total of five plastics layers. The first plastics layer 12 is disposed in the center and is formed of the hydrolysis-resistant polyamide 6. Additionally, the first plastics layer 12 is bounded internally and externally by, respectively, two further plastics layers. Additionally the first plastics layer 12 comprises, for example, 45% to 55%, preferably 50% per an embodiment, of the total extent of the pipe wall of the pipe of the fluid line 10.

The second plastics layer 14 extends around the first plastics layer 12. For this purpose the second plastics layer 14 bears directly against the first plastics layer 12. In this example it may comprise polyamide 612 and may make up, for example, 5% to 15%, preferably 10% per an embodiment, of the total extent of the pipe wall.

The third plastics layer 16 is enclosed by the first plastics layer 12 and bears directly against the first plastics layer 12. In this example the third plastics layer 16 may comprise a polypropylene and may contribute, for example, 5% to 15%, preferably 10% per an embodiment, to the extent of the pipe wall.

A fourth plastics layer 18 may extend within the third plastics layer 16 that is, the fourth plastics layer 18 is enclosed by the third plastics layer 16. In this example, the fourth plastics layer 18 may be produced from a further polypropylene material and may have, for example, 15% to 25%, preferably 20% per an embodiment, of the total extent of the pipe wall. In this example, the fourth plastics layer 18 forms the innermost layer of the fluid line 10.

A fifth plastics layer 20 may be provided as an external layer, which extends around the second plastics layer 14 and encloses all of the other plastics layers. This fifth plastics layer 18 may be produced from a polyamide 12 material and in radial direction 15 may contribute, for example, 5% to 15%, preferably 10% per an embodiment, to the overall extent of the pipe wall.

Furthermore, preferably per an embodiment, the fifth plastics layer 20 may additionally comprise colored pellets. In this way the fifth plastics layer 20 may be colored. The remaining fraction of the fifth plastics layer 20 may, moreover, additionally be formed by other substances which slightly modify the physical properties of the fifth plastics layer 20. The fundamental properties of the fifth plastics layer 20 are substantially not altered by the colored pellets and/or the additives.

FIG. 2b shows a sectional representation of a further example of a fluid line 10 having five plastics layers. The first plastics layer 12 is disposed directly after the outer layer and is formed of the hydrolysis-resistant polyamide 6. Moreover, the first plastics layer 12 is bounded internally and externally by the second plastics layer 14 and the third plastics layer 16. Moreover, the first plastics layer 12 in this example comprises 35% to 45%, preferably 40% per an embodiment, of the total extent of the pipe wall of the pipe of the fluid line 10.

The second plastics layer 14 here extends around a first plastics layer 12 and forms the outermost layer of the fluid line 10. The second plastics layer 14 bears directly against the first plastics layer 12. In this example the second plastics layer 14 may comprise polyamide 612 and may make up, for example, 5% to 15%, preferably 10% per an embodiment, of the total extent of the pipe wall.

Furthermore, preferably, the second plastics layer 14 may additionally comprise colored pellets. In this way the second plastics layer 14 may be colored. The remaining fraction of the second plastics layer 14, moreover, may additionally be formed by other substances which slightly modify the physical properties of the second plastics layer 14. The fundamental properties of the second plastics layer 14 are substantially not altered by the colored pellets and/or the additives.

The third plastics layer 16 is surrounded by the first plastics layer 12 and bears directly against the first plastics layer 12. In this example the third plastics layer 16 may comprise a polypropylene and may contribute, for example, 7% to 13%, preferably 10% per an embodiment, to the extent of the pipe wall.

A fourth plastics layer 18 may extend within a third plastics layer 16; i.e., the fourth plastics layer 18 is surrounded by the third plastics layer 16. In this example the fourth plastics layer 18 may be produced from a high-density polyethylene and may comprise, for example, 15% to 25%, preferably 20% per an embodiment, of the total extent of the pipe wall.

A sixth plastics layer 22 may be provided as a contact layer for the fluid flowing through the fluid line 10, this layer extending within the fourth plastics layer 18. In other words, the fourth plastics layer 18 surrounds the sixth plastics layer 22. This sixth plastics layer 18 may be produced from a polypropylene material and in radial direction 15 may contribute, for example, 10% to 20%, preferably 15% per an embodiment, to the total extent of the pipe wall.

FIG. 2c shows a sectional representation of a further example of the fluid line 10. In this example, however, the fluid line 10 comprises only four plastics layers. The first plastics layer 12 is arranged immediately after the outer layer and is formed of the hydrolysis-resistant polyamide 6. Moreover, the first plastics layer 12 is bounded internally and externally by the second plastics layer 14 and the third plastics layer 16. Moreover, in this example, the first plastics layer 12 comprises 55% to 65%, preferably 60% per an embodiment, of the total extent of the pipe wall of the pipe of the fluid line 10.

The second plastics layer 14 extends around the first plastics layer 12 and forms the outermost layer of the fluid line 10. The second plastics layer 14 bears directly against the first plastics layer 12. The second plastics layer 14 may in this example comprise polyamide 610 and may make up, for example, 10% to 20%, preferably 15% per an embodiment, of the total extent of the pipe wall.

Furthermore, preferably per an embodiment, the second plastics layer 14 may additionally comprise colored pellets. In this way the second plastics layer 14 may be colored. The remaining fraction of the second plastics layer 14, moreover, may additionally be formed by other substances which slightly modify the physical properties of the second plastics layer 14. The fundamental qualities of the second plastics layer 14 are substantially not altered by the colored pellets and/or the additives.

The third plastics layer 16 is surrounded by the first plastics layer 12 and bears from the inside directly against the first plastics layer 12. In this example, the third plastics layer 16 may comprise a polyphenylene sulfide and may contribute, for example, 5% to 15%, preferably 10% per an embodiment, to the extent of the pipe wall.

A fourth plastics layer 18 may extend within the third plastics layer 16; in other words, the fourth plastics layer 18 is surrounded by the third plastics layer 16. In this example, the fourth plastics layer 18 may be produced from a further polyphenylene sulfide material and may form the innermost layer of the fluid line 10. Moreover, the fourth plastics layer 18 may comprise, for example, 10% to 20%, preferably 15% per an embodiment, of the total extent of the pipe wall.

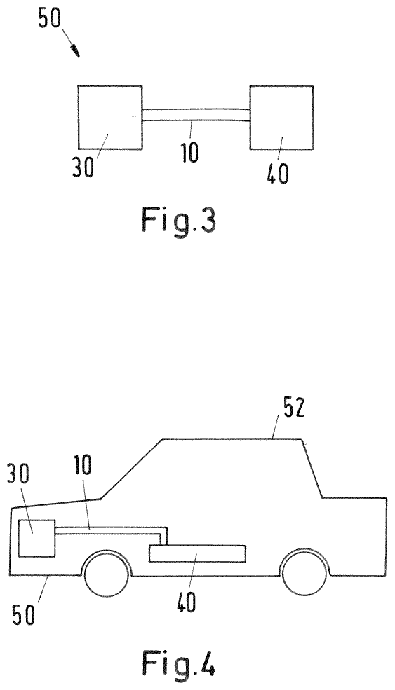

FIG. 3 shows a schematic representation of a system which is designated in its entirety by the reference numeral 50.

The cooling system comprises a cooling device 30 and an element 40 to be cooled. The cooling device 30 and the element 40 to be cooled are fluidically connected to one another via at least one fluid line 10 in accordance with the description given above. The fluid line 10 may in this case transport cooling water between the cooling device 30 and the element 40 to be cooled.

FIG. 4 shows a vehicle 52 which comprises a cooling system 50. The element 40 to be cooled may in this case, for example, be a battery of an electric vehicle. The cooling device 30 of the cooling system is in this case fluidically connected to the battery of the electric vehicle by means of a fluid line 10.

The invention is not confined to one of the embodiments described above, but instead can be modified in diverse ways.

All features and advantages emerging from the claims, the description and the drawing, including construction details, spatial arrangements and process steps, may be essential to the invention both on their own and in any of a wide variety of combinations.

All the features and advantages, including structural details, spatial arrangements and method steps, which follow from the claims, the description and the drawing can be fundamental to the invention both on their own and in different combinations. It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### LIST OF REFERENCE NUMERALS

10 fluid line

11 direction of extent

12 first plastics layer

14 second plastics layer

15 radial direction

16 third plastics layer

18 fourth plastics layer

20 fifth plastics layer

22 sixth plastics layer

30 cooling device

40 element to be cooled

50 cooling system

52 vehicle

1. A fluid line having a pipe which comprises at least two plastics layers, wherein a first plastics layer comprises hydrolysis-resistant polyamide 6 (PA6 ).

2. The fluid line of claim 1, wherein a second plastics layer is free from hydrolysis-resistant polyamide 6 (PA6 ).

3. The fluid line of claim 2, wherein the second plastics layer extends around the first plastics layer.

4. The fluid line of claim 3, wherein the second plastics layer comprises polyamide 612 (PA612).

5. The fluid line of claim 3, wherein the second plastics layer comprises polyamide 610 (PA610).

6. The fluid line of claim 2, wherein the first plastics layer extends around the second plastics layer.

7. The fluid line of claim 6, wherein the second plastics layer comprises polypropylene (PP).

8. The fluid line of claim 6, wherein the second plastics layer comprises polyethylene (PE).

9. The fluid line of claim 6, wherein the second plastics layer comprises polyphenylene sulfide (PPS).

10. The fluid line of claim 2, wherein the fluid line comprises at least three plastics layers, where the first plastics layer is arranged between the second plastics layer and a third plastics layer.

11. The fluid line of claim 10, wherein the third plastics layer is free from hydrolysis-resistant polyamide 6 (PA6 ).

12. The fluid line of claim 1, wherein the first plastics layer in radial direction comprises between 25% and 75% of a total extent of the at least two plastics layers of the pipe.

13. A cooling water system for a vehicle, wherein the cooling water system comprises a cooling device, an element to be cooled and at least one fluid line of claim 1, wherein the at least one fluid line fluidically connects the cooling device and the element to be cooled.

14. The use of a fluid line as claimed in claim 1 for conveying water in a vehicle.

15. The fluid line of claim 1, wherein the first plastics layer in radial direction comprises between 30% and 70% of a total extent of the at least two plastics layers of the pipe.

16. The fluid line of claim 1, wherein the first plastics layer in radial direction comprises between 40% and 60% of a total extent of the at least two plastics layers of the pipe.
